(19) United States
(12) Patent Application Publication
(10) Pub. No.: US 2021/0291684 A1
(43) Pub. Date: Sep. 23, 2021

(54) DISPLAY CONTROL APPARATUS, DISPLAY CONTROL METHOD, AND VEHICLE

(71) Applicant: PANASONIC INTELLECTUAL PROPERTY MANAGEMENT CO., LTD., Osaka (JP)

(72) Inventors: Hideyuki TAKAHASHI, Kanagawa (JP); Fumio KOSUGE, Tokyo (JP); Masao IKEDA, Kanagawa (JP); Takuya NAKAGAWA, Kanagawa (JP); Kiyotaka TANIMOTO, Kanagawa (JP)

(73) Assignee: PANASONIC INTELLECTUAL PROPERTY MANAGEMENT CO., LTD., Osaka (JP)

(21) Appl. No.: 17/208,269

(22) Filed: Mar. 22, 2021

(30) Foreign Application Priority Data
Mar. 23, 2020 (JP) 2020-051072

(51) Int. Cl. B60L 53/38; H02J 50/10; B60K 35/00; B60L 53/12

(52) U.S. Cl. CPC B60L 53/38; H02J 50/10; B60K 35/00; B60K 2370/149; B60K 2370/1529; B60K 2370/166; B60K 2370/171; B60L 53/12

(57) ABSTRACT

A display control apparatus is configured to control a display of a head-up display provided in a vehicle configured to receive power by a wireless power transfer. The display control apparatus includes: a processor; and a memory having instructions that, when executed by the processor, cause the processor to perform operations comprising: acquiring power supply position information indicating a position of a power supply apparatus that is installed in a road and configured to perform power reception by the wireless power transfer; and causing the head-up display to display guidance information that guides the vehicle to the position indicated by the power supply position information.

### FIELD

The present disclosure relates to a display control apparatus, a display control method, and a vehicle.

### BACKGROUND

A vehicle that is driven using electric power stored in a battery, such as an electric vehicle (EV), a hybrid vehicle (HV), or a plug-in hybrid vehicle (PHV) is known.

It is considered that a power supply apparatus (for example, a power supply coil or a primary-side coil) for a wireless power transfer is installed in a road, a power receiving apparatus (for example, a power receiving coil or a secondary-side coil) is installed on a vehicle, and the vehicle acquires electric power from the power supply apparatus and charges a battery while traveling on the road (for example, Patent Literature 1).

Patent Literature 1: JP-A-2016-152759

### SUMMARY

However, since the power supply apparatus is embedded in the road, a driver cannot visually recognize a position where the power supply apparatus is installed on the road (hereinafter, referred to as “power supply position”) during driving, and it is difficult to move the vehicle to the power supply position. Even when a mark indicating a position of the power supply apparatus is temporarily drawn on the road, for example, when another vehicle is present on the mark or dirt or snow is present on the mark, the driver cannot visually recognize the mark during driving, and it is difficult to move the vehicle to the power supply position.

An object of the present disclosure is to provide a technology for assisting a driver in moving a vehicle to a position on a road in which a power supply apparatus is installed.

The disclosure provides a display control apparatus configured to control a display of a head-up display provided in a vehicle configured to receive power by a wireless power transfer, the display control apparatus including: a processor; and a memory having instructions that, when executed by the processor, cause the processor to perform operations including: acquiring power supply position information indicating a position of a power supply apparatus that is installed in a road and configured to perform power reception by the wireless power transfer; and causing the head-up display to display guidance information that guides the vehicle to the position indicated by the power supply position information.

The disclosure provides a display control method for controlling a display of a head-up display provided in a vehicle configured to receive power by a wireless power transfer, the display control method including: acquiring power supply position information indicating a position of a power supply apparatus that is installed in a road and configured to perform power reception by the wireless power transfer, and causing the head-up display to display guidance information that guides the vehicle to the position indicated by the power supply position information.

The disclosure provides a vehicle configured to receive power by a wireless power transfer, the vehicle including: a head-up display; a processor; and a memory having instructions that, when executed by the processor, cause the processor to perform operations including: acquiring power supply position information indicating a position of a power supply apparatus that is installed in a road and configured to perform power reception by the wireless power transfer; and causing the head-up display to display guidance information that guides the vehicle to the position indicated by the power supply position information.

These comprehensive or specific modes may be implemented by a system, an apparatus, a method, an integrated circuit, a computer program, or a recording medium, or may be implemented by any combination of a system, an apparatus, a method, an integrated circuit, a computer program, and a recording medium.

According to the present disclosure, it is possible to assist a driver in moving a vehicle to a position on a road in which a power supply apparatus is installed.

### BRIEF DESCRIPTION OF DRAWINGS

FIG. 1 is a diagram showing an example of a vehicle capable of receiving power by a wireless power transfer according to the present embodiment.

FIG. 2 is a block diagram showing an example of an apparatus provided in the vehicle according to the present embodiment.

FIG. 3 is a block diagram showing an example of functions and information of a display control apparatus according to the present embodiment.

FIG. 4 is a flowchart showing an example of a processing of a display control unit according to the present embodiment.

FIG. 5 is a diagram showing a display example of a warning prompting a WPT button to be turned on on a HUD.

FIG. 6A is a diagram showing a first example of displaying path information to a power supply position on the HUD.

FIG. 6B is a diagram showing a second example of displaying path information to the power supply position on the HUD. FIG. 7 is a diagram showing a display example of a power supply position image and a traveling trajectory image on the HUD.

FIG. 8 is a diagram for illustrating a relationship between the traveling trajectory image and the vehicle.

FIG. 9 is a flowchart showing an example of a generation processing of the traveling trajectory image.

FIG. 10 is a diagram showing a display example of information indicating that charging is being performed on the HUD.

FIG. 11 is a diagram showing a modified example of displaying the power supply position images and the traveling trajectory image on the HUD.

### DETAILED DESCRIPTION

Hereinafter, an embodiment of the present disclosure will be described in detail with reference to the drawings as appropriate. However, unnecessarily detailed description may be omitted. For example, detailed description of well-known matters and repeated description of substantially the same configurations may be omitted. This is to avoid unnecessary redundancy in the following description and to facilitate understanding by those skilled in the art. The accompanying drawings and the following description are provided to those skilled in the art to fully understand the present disclosure, and are not intended to limit the claimed subject matter by these.

### Embodiment

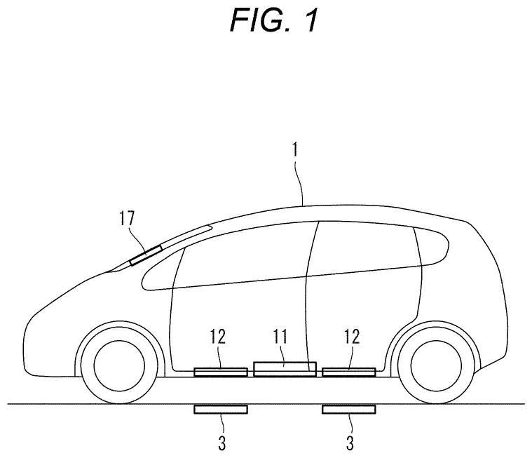

FIG. 1 is a diagram showing an example of a vehicle capable of receiving power by a wireless power transfer according to the present embodiment.

A vehicle 1 is an electric vehicle that includes a battery 11 and is driven by using electric power stored in the battery 11. The vehicle 1 may be any one of an electric vehicle (EV), a hybrid vehicle (HV), a plug-in hybrid vehicle (PHV), or the like. Further, the vehicle 1 may be any one of a private vehicle, a bus, a truck, a taxi, a trailer, a motorcycle, or the like.

The vehicle 1 according to the present embodiment is capable of receiving power by the wireless power transfer. For example, as shown in FIG. 1, the vehicle 1 includes power receiving apparatuses 12 for acquiring electric power in a non-contact manner from power supply apparatuses 3 embedded in a road. The wireless power transfer may be either an electromagnetic induction type or a magnetic field resonance type. The power supply apparatus 3 may be read as another term such as a power supply coil or a primary-side coil. The power receiving apparatus 12 may be read as another term such as a power receiving coil or a secondary-side coil. The power receiving apparatus 12 charges the battery 11 with electric power acquired from the power supply apparatus 3.

For example, by embedding the power supply apparatus 3 in a road in front of an intersection where a traffic light is installed, the vehicle 1 stopped at a red light can acquire electric power from the power supply apparatus 3 to charge the battery 11. Further, for example, by continuously embedding a plurality of power supply apparatuses 3 in a certain lane, the vehicle 1 can acquire electric power from the power supply apparatuses 3 to charge the battery 11 while traveling in the lane.

However, since the power supply apparatus 3 is embedded in the road, a driver cannot visually recognize a position of the power supply apparatus 3 (hereinafter, referred to as “power supply position”). Even when a mark indicating a power supply position is temporarily drawn on the road, for example, in a case where another vehicle is present on the mark or dirt or snow is present on the mark, the driver cannot visually recognize the mark. Therefore, in the present embodiment, information on the power supply position is displayed on a head-up display (HUD) 17 provided in the vehicle 1. Accordingly, the driver can confirm the information on the power supply position from the HUD 17 while driving the vehicle 1, and thus can easily move the vehicle 1 to the power supply position. The details will be described below.

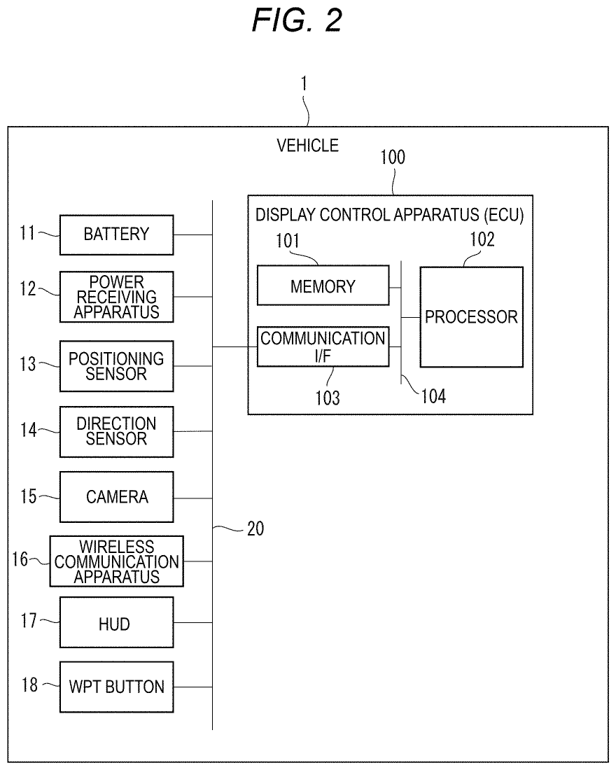

FIG. 2 is a block diagram showing an example of apparatuses provided in the vehicle 1 according to the present embodiment.

The vehicle 1 includes the battery 11, the power receiving apparatuses 12, a positioning sensor 13, a direction sensor 14, a camera 15, a wireless communication apparatus 16, the HUD 17, a wireless power transfer (WPT) button 18, and a display control apparatus 100 that is an example of an electronic control unit (ECU). These components 11 to 18 and 100 can transmit/receive information to/from one another through, for example, an in-vehicle network 20. Examples of the in-vehicle network 20 include a controller area network (CAN), a local interconnect network (LIN), and a FlexRay.

The battery 11 stores electric power for driving the vehicle 1. The battery 11 is configured with, for example, a nickel-metal hydride battery or a lithium-ion battery.

The power receiving apparatuses 12 acquire electric power in a non-contact manner from the power supply apparatuses 3 installed in a road to charge the battery 11 with the acquired electric power.

The positioning sensor 13 specifies a position of the vehicle 1 based on, for example, a global positioning system (GPS) reception signal.

The direction sensor 14 specifies a direction (an orientation) in which the vehicle 1 faces, based on, for example, a measurement result of geomagnetism.

The camera 15 captures an image of, for example, surroundings of the vehicle 1 and generates a captured image. The captured image is used for various purposes. For example, the captured image is used to specify a lane of a road, a traffic sign, another vehicle, a pedestrian, and the like. Further, the captured image is used to specify a position and a direction of the vehicle 1 in more detail. For example, the position and the direction of the vehicle 1 can be specified in more detail by collating the captured image with 3D high accuracy map information.

The wireless communication apparatus 16 corresponds to a mobile communication system such as 4G or 5G, and transmits and receives information to and from a predetermined server, another vehicle, or the like by using a wireless signal.

The HUD 17 is an apparatus that projects an image on a windshield and is provided, for example, on an instrument panel of the vehicle 1. Alternatively, the HUD 17 is a translucent display capable of displaying an image and is provided, for example, in the instrument panel of the vehicle 1. The driver can visually recognize a situation in front (for example, a road surface of a road, a traffic light, other vehicles, and the like) through the HUD 17.

The WPT button 18 is a button used for setting ON and OFF of a wireless power transfer mode by the power receiving apparatuses 12 and is provided, for example, in the vicinity of a driver seat. The driver can operate the WPT button 18 to set whether to receive an electric power supply from the power supply apparatuses 3. When the WPT button 18 is set to ON, the power receiving apparatuses 12 receive the electric power supply from the power supply apparatuses 3. When the WPT button 18 is set to OFF, the power receiving apparatuses 12 do not receive the electric power supply from the power supply apparatuses 3.

The display control apparatus 100, which is an example of the ECU, is an apparatus that controls a display of the HUD 17. The display control apparatus 100 includes a memory 101, a processor 102, and a communication interface (I/F) 103. These components 101 to 103 can transmit/receive information to/from one another through, for example, a bus 104.

The memory 101 stores a computer program and data related to functions of the display control apparatus 100. The memory 101 is configured with, for example, a read only memory (ROM), a random access memory (RAM), or a combination thereof.

The processor 102 executes the computer program read from the memory 101 and/or a processing incorporated in advance, and implements the functions of the display control apparatus 100. The processor 102 may be read as another term such as a controller, a central processing unit (CPU), an integrated circuit, an application specific integrated circuit (ASIC), a programmable logic device (PLD), or a field-programmable gate array (FPGA).

The communication I/F 103 controls transmission and reception of data to and from other ECUs via the in-vehicle network 20. The communication I/F 103 may be read as another term such as a communication apparatus, a communication interface or a communication module. The communication I/F 103 includes a transmission unit that controls transmission of data and a reception unit that controls reception of data.

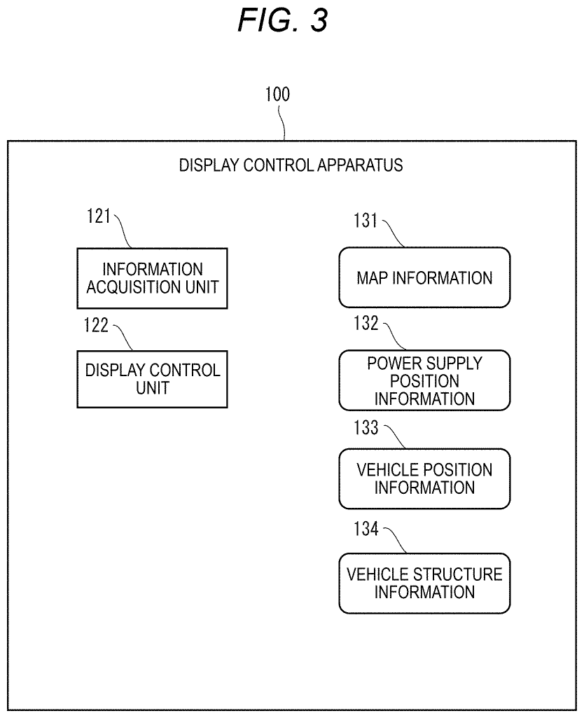

FIG. 3 is a block diagram showing an example of the functions and information of the display control apparatus 100 according to the present embodiment. The functions may be implemented by the processor 102 operating in cooperation with the memory 101 and the communication I/F 103. Further, the information may be stored in the memory 101.

Map information 131 is information indicating a map of a road. The map information 131 also includes information on the number of lanes and a lane width. The map information 131 is, for example, 3D high accuracy map information.

Power supply position information 132 is information indicating positions of the power supply apparatuses 3 on the road (power supply positions). The power supply position information 132 may be included in the map information 131.

Vehicle position information 133 is information indicating a position and a direction of the vehicle 1. The vehicle position information 133 may be generated based on the position and the direction of the vehicle 1 specified by the positioning sensor 13 and the direction sensor 14. Further, the vehicle position information 133 may be generated based on the position and the direction of the vehicle 1 specified by collating a captured image captured by the camera 15 with the 3D high accuracy map information. The vehicle position information 133 may be generated by the display control apparatus 100 or may be generated by another ECU. Alternatively, the vehicle position information 133 may be generated by the predetermined server and downloaded from the server through the wireless communication apparatus 16.

Vehicle structure information 134 is information indicating a structure of the vehicle 1. The vehicle structure information 134 may include a width of the vehicle 1 and a length (a total length) of the vehicle 1. Further, the vehicle structure information 134 may include information indicating the positions of the power receiving apparatuses 12 of the vehicle 1. The vehicle structure information 134 may be stored in the memory 101 in advance.

An information acquisition unit 121 acquires information from another ECU and/or a sensor or the like through the communication I/F 103 and stores the acquired information in the memory 101. For example, the information acquisition unit 121 acquires the vehicle position information 133 from another ECU and stores the acquired vehicle position information 133 in the memory 101. Further, the information acquisition unit 121 receives information from the predetermined server through the communication I/F 103 and the wireless communication apparatus 16, and stores the received information in the memory 101. For example, the information acquisition unit 121 receives the map information 131 and the power supply position information 132 from the predetermined server and stores the map information 131 and the power supply position information 132 in the memory 101.

A display control unit 122 controls a display of the HUD 17. For example, the display control unit 122 causes guidance information, which is information for guiding the vehicle 1 to a position indicated by the power supply position information 132, to be displayed on the HUD 17. Details of the display control unit 122 will be described later.

<Details of Display Control Unit>

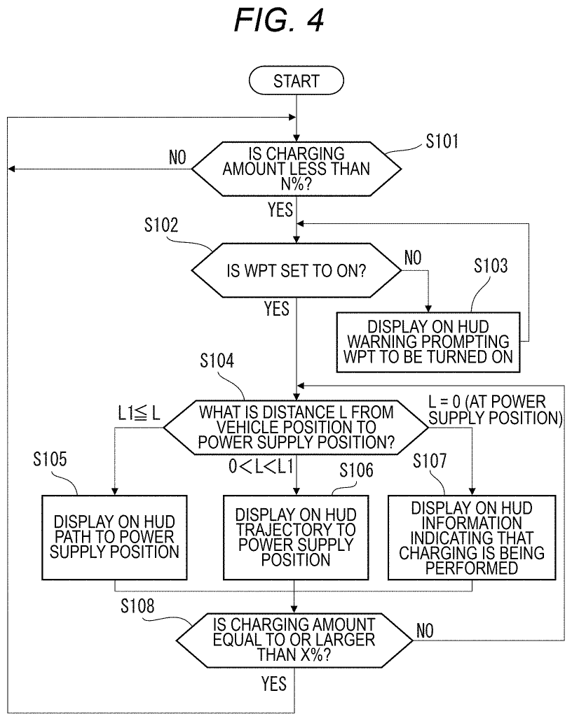

FIG. 4 is a flowchart showing an example of a processing of the display control unit 122 according to the present embodiment.

The display control unit 122 periodically determines whether a remaining amount of the battery 11 is less than a threshold N % (S101). N is a predetermined positive value, for example, 30 (%).

When the remaining amount of the battery 11 is equal to or larger than N % (S101: NO), the display control unit 122 continues to monitor the remaining amount of the battery 11.

When the remaining amount of the battery 11 is less than N % (S101: YES), the display control unit 122 determines whether the WPT button 18 is ON (S102).

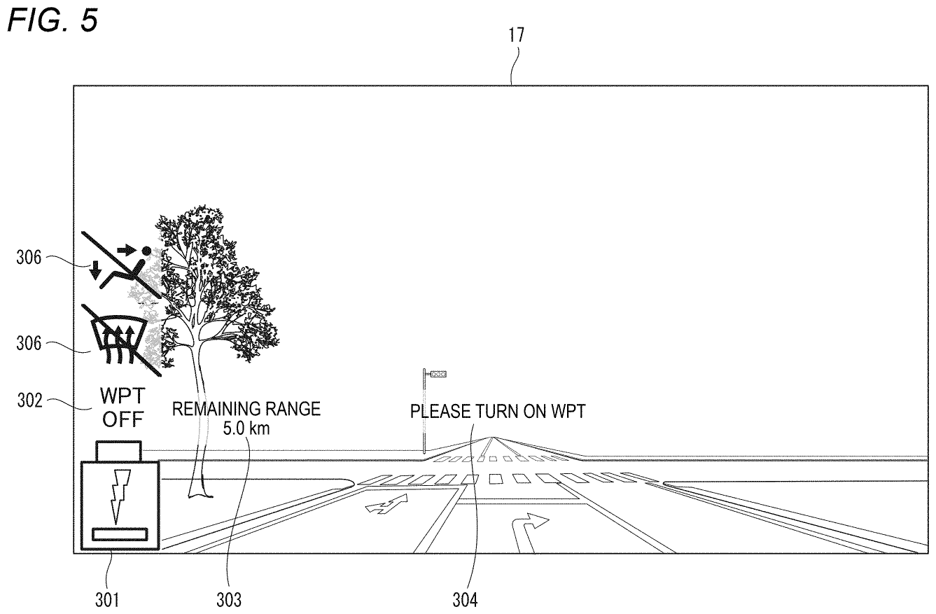

When the WPT button 18 is OFF (S102: NO), the display control unit 122 causes a warning prompting the WPT button 18 to be turned on to be displayed on the HUD 17 (S103), and returns to the processing of S102. This is because the remaining amount of the battery 11 is insufficient, and it is preferable to charge the battery 11 as soon as possible. A display example of the warning prompting the WPT button 18 to be turned on will be described later (see FIG. 5).

When the WPT button 18 is ON (S102: YES), the display control unit 122 specifies a power supply position closest (nearest) to a current position of the vehicle 1 based on the power supply position information 132. Then, the display control unit 122 determines which of the following is a path distance L from the current position of the vehicle 1 to the specified power supply position (S104).

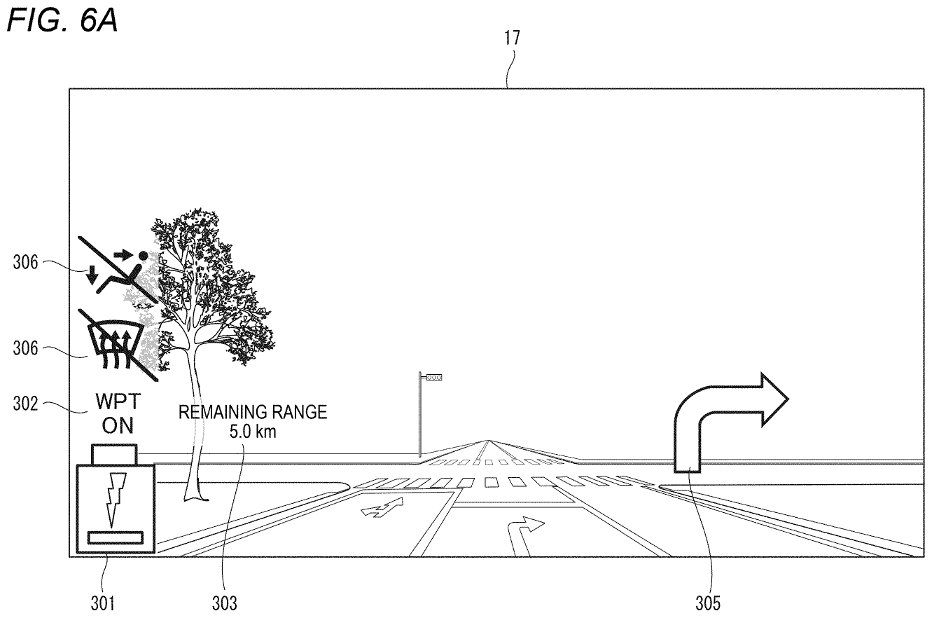

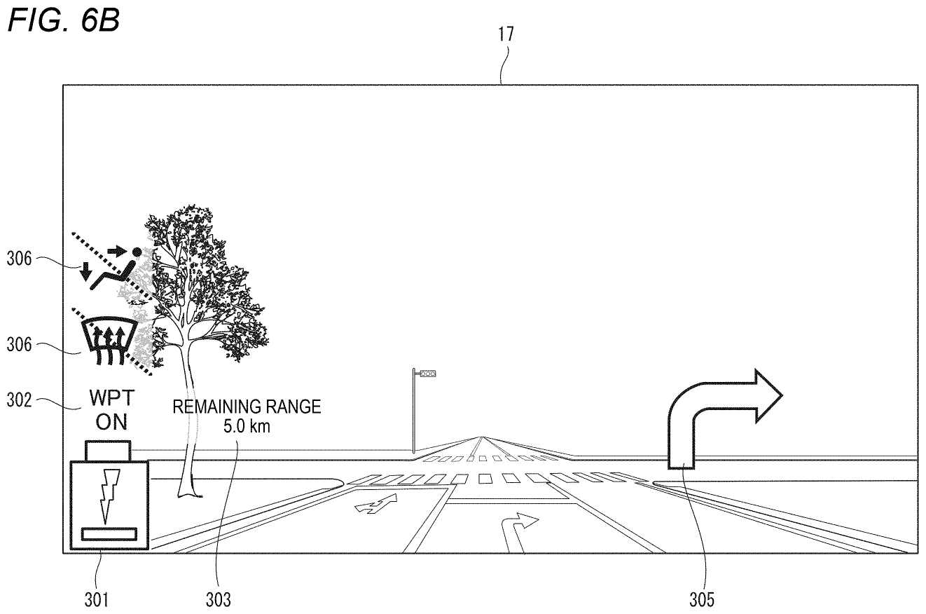

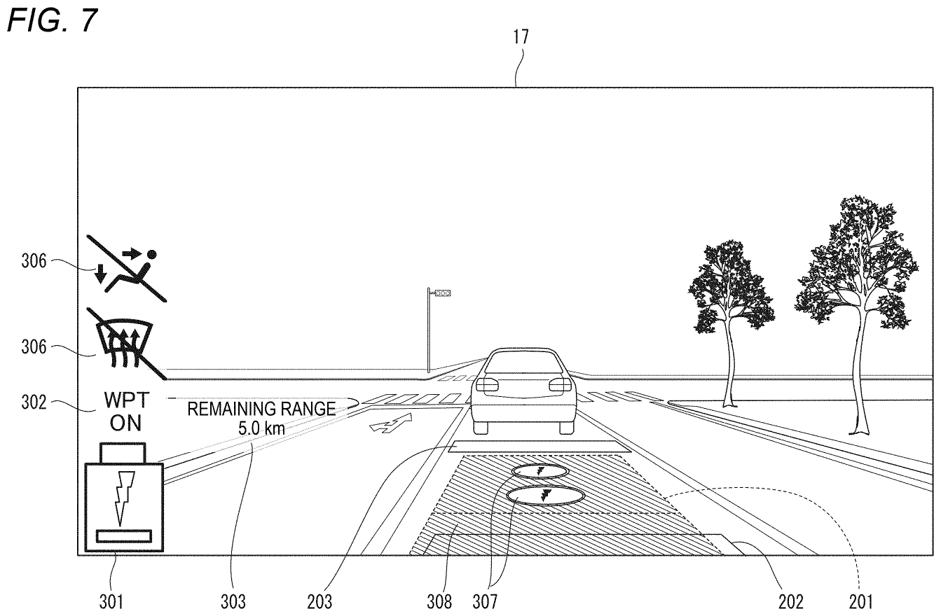

When the path distance L is equal to or larger than a threshold L1(S104: L1≤L), the display control unit 122 causes information 305 indicating a path to the power supply position (hereinafter, referred to as “path information”) to be displayed on the HUD 17 as the guidance information (S105), and proceeds to a processing of S108. L1 is a predetermined positive value, for example, 30 m. A display example of the path information 305 will be described later (see FIG. 6).

When the path distance L is larger than 0 and less than the threshold L1 (S104: 0<L<L1), the display control unit 122 causes an image 307 showing the power supply position (hereinafter, referred to as “power supply position image”) and an image 308 showing a recommended traveling trajectory to the power supply position (hereinafter, referred to as “traveling trajectory image”) to be displayed on the HUD 17 (S106), and proceeds to the processing of S108. Display examples of the power supply position image 307 and the traveling trajectory image 308 will be described later (see FIG. 7).

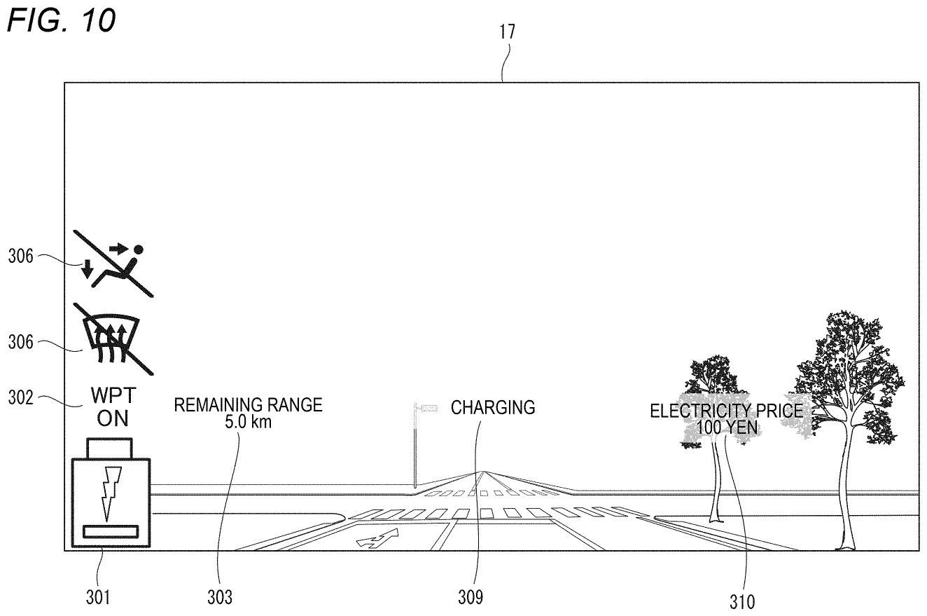

When the path distance L is 0 (S104: L=0), that is, when the vehicle 1 is stopped (or traveling) on the power supply position, the display control unit 122 causes information indicating that charging is being performed to be displayed on the HUD 17 (S107), and proceeds to the processing of S108. A display example of information indicating that charging is being performed will be described later (see FIG. 10).

The display control unit 122 acquires the remaining amount of the battery 11 after the vehicle 1 is stopped and charged on the power supply position, and determines whether the remaining amount of the battery 11 is equal to or larger than a threshold X % (S108). X is a predetermined positive value, for example, 90 (%).

When the remaining amount of the battery 11 is less than the threshold X % (S108: NO), the display control unit 122 returns to the processing of S104 for path guidance to a next power supply position. When the remaining amount of the battery 11 is equal to or larger than the threshold X % (S108: YES), the display control unit 122 ends the path guidance processing and returns to the monitoring of the remaining amount of the battery 11 (START in the flowchart).

<Warning Display>

FIG. 5 is a diagram showing a display example of a warning prompting the WPT button to be turned on on the HUD 17.

As shown in FIG. 5, the display control unit 122 displays remaining amount information 301, WPT setting information 302, and a remaining traveling distance 303 on the HUD 17.

The remaining amount information 301 is information indicating the remaining amount of the battery 11 and is displayed as an icon as shown in FIG. 5 as an example. The remaining amount information 301 may be displayed in different modes (for example, different colors or shapes) depending on whether the remaining amount of the battery 11 is equal to or larger than N % or less than N %. Alternatively, the remaining amount information 301 may be displayed as a numerical value indicating the remaining amount of the battery 11.

The WPT setting information 302 is information indicating whether setting of the WPT button 18 is ON or OFF. The WPT setting information 302 may be displayed in different modes (for example, different characters, colors or shapes) depending on whether the setting of the WPT button 18 is ON or OFF.

The remaining range 303 is information indicating a distance over which the vehicle 1 can travel with a current remaining amount of the battery 11 (i.e., a distance to empty). The remaining range 303 may be displayed in different modes (for example, different colors) depending on the situation in which the remaining range is equal to or larger than a predetermined distance or the situation in which the remaining range is less than the predetermined distance.

When the remaining amount of the battery 11 is less than N % and the setting of the WPT button 18 is OFF, the display control unit 122 causes a message such as “Please turn on WPT” to be displayed on the HUD 17 as an example of warning information 304 prompting the WPT button 18 to be turned on, as illustrated in FIG. 5. Accordingly, the driver can notice a necessity of setting the WPT button 18 to ON by viewing the warning information 304 displayed on the HUD 17 even while driving.

When the remaining amount of the battery 11 is less than N %, in order to suppress consumption of the battery 11, the predetermined ECU provided in the vehicle 1 may stop operations of some apparatuses that consume the battery 11, such as an air conditioner and a heater. In this case, as illustrated in FIG. 5, the display control unit 122 may cause icons 306 indicating the stop of the operations of the air conditioner, the heater, and the like to be displayed on the HUD 17. Accordingly, the driver can recognize from a display of the HUD 17 that the operations of the air conditioner, the heater, and the like are stopped in order to suppress the consumption of the battery 11.

Alternatively, when the remaining amount of the battery 11 is less than N %, in order to suppress the consumption of the battery 11, the display control unit 122 may cause an icon (see FIG. 6B) prompting the stop of the operations of the air conditioner, the heater, and the like to be displayed on the HUD 17. Accordingly, the driver can recognize from the display of the HUD 17 that the stop of the operations of the air conditioner, the heater, and the like is prompted in order to suppress the consumption of the battery 11.

<Path Display>

FIGS. 6A and 6B are diagrams showing display examples of the path information 305 to the power supply position on the HUD 17.

When the remaining amount of the battery 11 is less than N % and the path distance L to a nearest power supply position is equal to or larger than the threshold L1, the display control unit 122 causes the path information 305 indicating a path to the nearest power supply position as the guidance information to be displayed on the HUD 17 as illustrated in FIG. 6A. Accordingly, even when the power supply position is relatively far, the driver can move the vehicle 1 to the power supply position while viewing the HUD 17.

A condition under which the display control unit 122 displays the path information 305 is not limited to the above condition. For example, the display control unit 122 may display the path information 305 when any one of the following conditions (A1) to (A3) is satisfied.

(A) when the driver performs an operation of displaying the path information 305, (A2) when the nearest power supply position cannot be visually recognized by the driver, and

(A3) when at least one right turn or left turn is required to reach the nearest power supply position.

When the remaining amount of the battery 11 is less than N %, in order to suppress the consumption of the battery 11, the predetermined ECU provided in the vehicle 1 may stop the operations of some apparatuses that consume the battery 11, such as the air conditioner and the heater. In this case, as illustrated in FIG. 6A, the display control unit 122 may cause the icons 306 (for example, icons with solid diagonal lines) indicating that the operations of the air conditioner, the heater, and the like are stopped to be displayed on the HUD 17. Accordingly, the driver can recognize from the display of the HUD 17 that the operations of the air conditioner, the heater, and the like are stopped in order to suppress the consumption of the battery 11.

Alternatively, when the remaining amount of the battery 11 is less than N %, in order to suppress the consumption of the battery 11, the display control unit 122 may cause the icons 306 (for example, icons with dotted diagonal lines) prompting the stop of the operations of the air conditioner, the heater, and the like to be displayed on the HUD 17, as illustrated in FIG. 6B. Accordingly, the driver can recognize from the display of the HUD 17 that the stop of the operations of the air conditioner, the heater, and the like is prompted in order to suppress the consumption of the battery 11.

The display control unit 122 may cause path information to a destination set in car navigation to be displayed on the HUD 17 together with the path information 305 to the power supply position. In this case, the display control unit 122 may cause the path information 305 to the power supply position and the path information to the destination to be displayed in a distinguishable mode. For example, the path information 305 to the power supply position and the path information to the destination may be displayed in colors or shapes different from each other. Accordingly, the driver can easily distinguish between a path toward the power supply position and a path toward the destination by viewing the HUD 17.

<Traveling Trajectory Display>

FIG. 7 is a diagram showing a display example of the power supply position image 307 and the traveling trajectory image 308 on the HUD 17.

When the remaining amount of the battery 11 is less than N % and the path distance L to the nearest power supply position is larger than 0 and less than the threshold L1, the display control unit 122 executes the following processings of S11 to S13.

(S11) The display control unit 122 specifies an actual power supply position, which is a position on a road of a perspective destination of the HUD 17, corresponding to the nearest power supply position. For example, the display control unit 122 specifies the actual power supply position based on a captured image of the camera 15, the 3D high accuracy map information, and the power supply position information 132.

(S12) The display control unit 122 specifies a traveling trajectory that reaches the actual power supply position. For example, the display control unit 122 specifies a traveling lane and a lane of the power supply position based on the captured image of the camera 15, the 3D high accuracy map information, and the power supply position information 132, and specifies a traveling trajectory from the traveling lane to the lane of the power supply position.

(S13) As illustrated in FIG. 7, the display control unit 122 causes the power supply position image 307 to be displayed at a position of the HUD 17 corresponding to the actual power supply position as the guidance information. In addition, as illustrated in FIG. 7, the display control unit 122 causes the traveling trajectory image 308 to be displayed in an area of the HUD 17 corresponding to the traveling trajectory as the guidance information.

Accordingly, since the power supply position image 307 and the traveling trajectory image 308 appear to be superimposed on a road of a sight line destination through the HUD 17, the driver can easily move the vehicle 1 to the power supply position. That is, even when the power supply apparatuses 3 cannot be visually recognized, the driver can easily move the vehicle 1 to the power supply position by using the power supply position image 307 and the traveling trajectory image 308 displayed on the HUD 17 as markers.

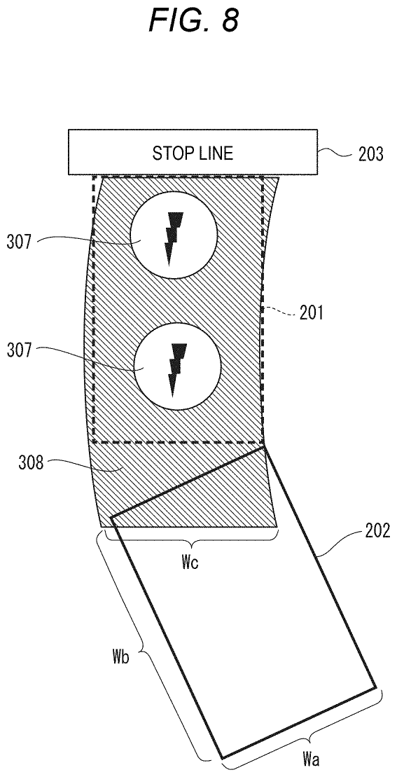

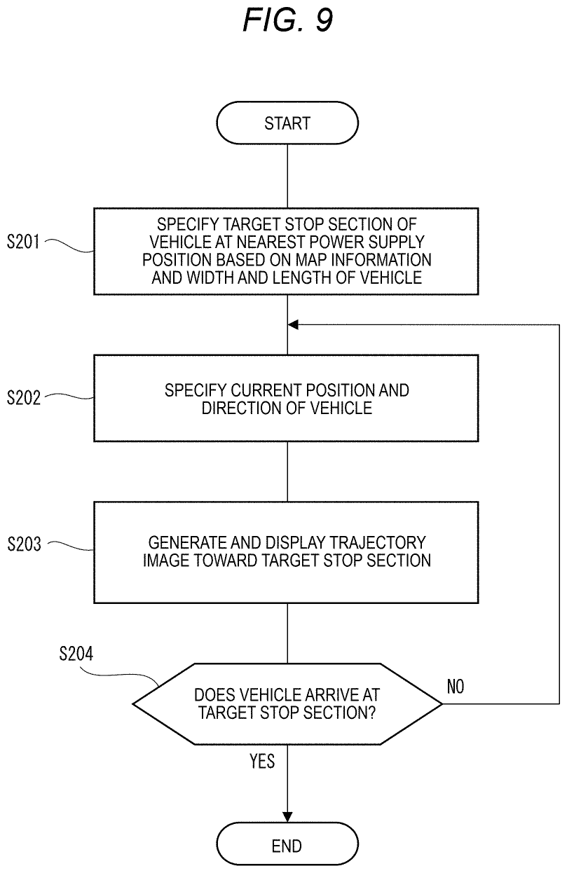

Next, a method for generating the traveling trajectory image 308 will be described with reference to FIGS. 7, 8, and 9. FIG. 8 is a diagram for illustrating a relationship between the traveling trajectory image 308 and the vehicle 1. FIG. 9 is a flowchart showing an example of a generation processing of the traveling trajectory image 308.

The display control unit 122 specifies a target stop section 201 and a WPT stop line 203 of the vehicle 1 at the nearest power supply position based on the map information 131, the power supply position information 132, and a width Wa of the vehicle 1 and a length Wb of the vehicle 1 included in the vehicle structure information 134 (S201). For example, the display control unit 122 specifies the target stop section 201 such that a deviation between the power receiving apparatuses 12 on a vehicle 1 side and the power supply apparatuses 3 on a road side is as small as possible. At this time, the display control unit 122 sets a width We of the target stop section 201 to be substantially the same as the width Wa of the vehicle 1. Accordingly, since a positional deviation between the power receiving apparatuses 12 of the vehicle 1 stopped according to the target stop section 201 and the power supply apparatuses 3 in the road is reduced, the power receiving apparatuses 12 can efficiently acquire electric power. Further, the WPT stop line 203 may be set at a position of a stop line when there is no other vehicle in front, and may be set at a position in front of another vehicle in front when there is another vehicle in front.

The display control unit 122 specifies a current position 202 and a direction of the vehicle 1 based on the vehicle position information 133 (S202).

The display control unit 122 generates the traveling trajectory image 308 from the current position 202 and the direction of the vehicle 1 to the target stop section 201, and causes the generated traveling trajectory image 308, an image showing the current position 202, an image showing the target stop section 201, and an image showing the WPT stop line 203 to be displayed on the HUD 17 (S203).

The display control unit 122 determines whether the vehicle 1 has arrived at the target stop section 201 (S204). When the vehicle 1 has not arrived at the target stop section 201 (S204), the display control unit 122 returns to the processing of S202. When the vehicle 1 has arrived at the target stop section 201 (S205), the display control unit 122 ends the processing.

According to the above processing, the display control unit 122 can update the traveling trajectory image 308 at any time according to the current position and the direction of the vehicle 1 and cause the updated traveling trajectory image 308 to be displayed on the HUD 17 until the vehicle 1 arrives at the target stop section 201. Further, an image of the target stop section 201 can visually guide the vehicle 1. The traveling trajectory image 308 can visually prevent a deviation of the vehicle 1 in a left-right direction. An image of the current position 202 can visually guide the vehicle 1 so as to match the target stop section 201. Therefore, the driver can easily stop the vehicle 1 at the position of the target stop section 201 while viewing the images displayed on the HUD 17.

<Charging Display>

FIG. 10 is a diagram showing a display example of information indicating that charging is being performed on the HUD 17.

While the path distance L is 0 (that is, the vehicle 1 is stopped or traveling in the target stop section 201) and the power receiving apparatuses 12 are acquiring electric power from the power supply apparatuses 3 in the road, the display control unit 122 causes a message such as “charging” to be displayed on the HUD 17 as charging information 309 indicating that charging is being performed, as illustrated in FIG. 10. The display control unit 122 may cause a predetermined icon indicating that charging is being performed to be displayed on the HUD 17 instead of the message. Accordingly, the driver can easily recognize that the vehicle 1 is being charged by viewing the charging information 309 indicating that the vehicle 1 is being charged, which is displayed on the HUD 17, even when the vehicle 1 is being driven.

As illustrated in FIG. 10, the display control unit 122 may cause, an electricity price 310 corresponding to electric energy acquired from the power supply apparatuses 3 or the electricity price 310 corresponding to electric energy transmitted by the power supply apparatuses 3, to be displayed on the HUD 17. Accordingly, the driver can easily grasp the electricity price for charging. The display control unit 122 may cause an electricity price corresponding to one power supply during stop to be displayed, or may cause an electricity price corresponding to a total power supply during one traveling (from starting an engine until turning off the engine) to be displayed. Alternatively, the display control unit 122 may cause a monthly electricity price of the driver including an electricity price corresponding to the power supply to be displayed.

The display control unit 122 may calculate a power transmission efficiency based on electric energy acquired from the power supply apparatuses 3 by the vehicle 1 and electric energy transmitted by the power supply apparatuses 3, and cause the calculated power transmission efficiency to be displayed on the HUD 17.

<Modified Example of Traveling Trajectory Display>

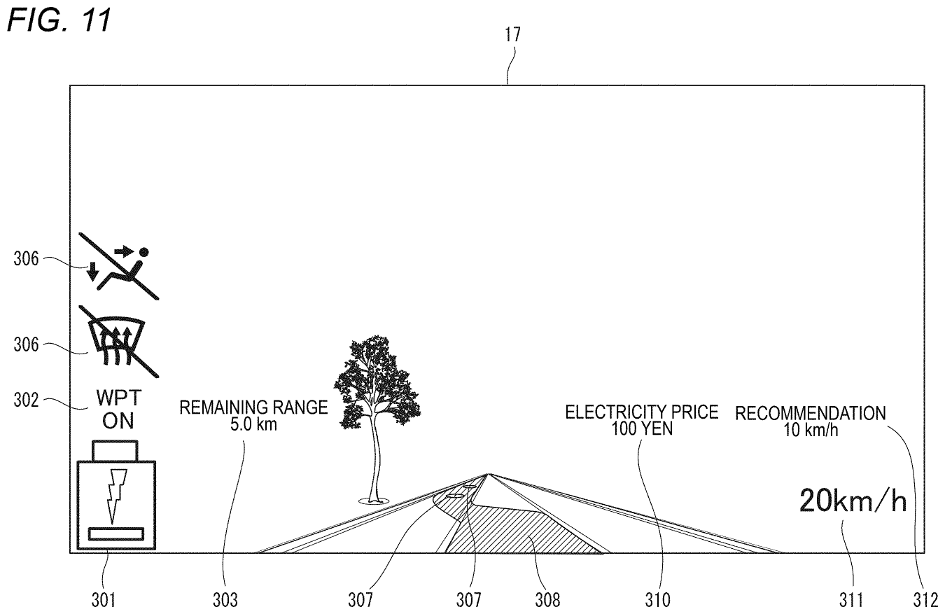

FIG. 11 is a diagram showing a modified example of displaying the power supply position images 307 and the traveling trajectory image 308 on the HUD 17.

FIG. 7 illustrates an example in which the traveling trajectory image 308 for guiding the vehicle 1 to the power supply apparatuses 3 installed in front of the stop line is displayed on the HUD 17. FIG. 11 describes an example in which the traveling trajectory image 308 for guiding the vehicle 1 to a lane in which the power supply apparatuses 3 are continuously installed (hereinafter, referred to as “power supply lane”) is displayed on the HUD 17.

When the power supply lane is present at a traveling destination of the vehicle 1, as shown in FIG. 11, the display control unit 122 causes the traveling trajectory image 308 for guiding the vehicle 1 from the traveling lane to the power supply lane to be displayed in an area of the HUD 17 corresponding to an actual lane at a sight line destination of the driver through the HUD 17. The traveling trajectory image 308 may be generated by the method described with reference to FIGS. 8 and 9.

As shown in FIG. 11, in addition to a current speed 311 of the vehicle 1, the display control unit 122 may cause a recommended speed 312 at the time of traveling in the power supply lane to be displayed on the HUD 17. The recommended speed 312 may be a speed of a vehicle at which the electric power supply by the wireless power transfer is equal to or higher than a predetermined efficiency. Information on the recommended speed 312 may be included in the map information 131 and/or the power supply position information 132.

The driver may cause the vehicle 1 to travel at the recommended speed 312 or less according to the traveling trajectory image 308 superimposed and displayed on the HUD 17. Accordingly, the vehicle 1 can efficiently acquire electric power from the power supply lane while traveling. Alternatively, the driver can avoid a power supply in which an electricity price is generated by causing the vehicle 1 to travel in a lane different from the power supply lane on which the traveling trajectory image 308 is superimposed and displayed.

### Summary of Present Disclosure

A display control apparatus (100) configured to control a display of a head-up display (HUD) provided in a vehicle (1) capable of receiving power by a wireless power transfer according to the present disclosure, the display control apparatus (100) includes: an acquisition unit (121) configured to acquire power supply position information (132) indicating a position of a power supply apparatus (3) that is installed in a road and configured to perform the wireless power transfer; and a control unit (102) configured to cause guidance information that guides the vehicle to a position indicated by the power supply position information to be displayed on the HUD.

According to this configuration, since the guidance information to a power supply position installed on the road is displayed on the HUD, a driver can easily move the vehicle to the power supply position by viewing the guidance information displayed on the HUD.

The control unit may cause information (302) indicating whether the vehicle is set to perform power reception by the wireless power transfer to be displayed on the HUD.

According to this configuration, since the information indicating whether the vehicle is set to perform the power reception by the wireless power transfer is displayed on the HUD, the driver can easily recognize whether the vehicle is set to perform the power reception by the wireless power transfer from the display of the HUD.

When a remaining amount of a battery of the vehicle is less than a predetermined threshold, the control unit may cause, an icon indicating that an air conditioner and/or a heater are/is stopped in order to suppress consumption of the battery, or an icon prompting a user to stop using the air conditioner and/or the heater in order to suppress the consumption of the battery, to be displayed on the HUD.

According to this configuration, the driver can recognize that the air conditioner and/or the heater are/is stopped in order to suppress the consumption of the battery, or that it is preferable to stop the air conditioner and/or the heater in order to suppress the consumption of the battery.

When the remaining amount of the battery (11) of the vehicle is less than a predetermined threshold and the vehicle is set not to perform the power reception by the wireless power transfer, the control unit may cause information (304) prompting a change to setting for performing the power reception by the wireless power transfer to be displayed on the HUD.

According to this configuration, when the remaining amount of the battery of the vehicle is less than the predetermined threshold and the vehicle is set not to perform the power reception by the wireless power transfer, since the information prompting the change to the setting for performing the power reception by the wireless power transfer is displayed on the HUD, the driver can change the display of the HUD to setting to perform the power reception by the wireless power transfer without forgetting before the battery becomes empty

The acquisition unit may acquire map information (131). The control unit may acquire vehicle position information (133) indicating a current position of the vehicle, specify a path from a position indicated by the vehicle position information to a position indicated by the power supply position information based on the map information, and cause information (305) indicating the specified path to be displayed on the HUD as the guidance information.

According to this configuration, since the path from the current position of the vehicle to the position indicated by the power supply position information is displayed on the HUD, the driver can move the vehicle to a position of the power supply apparatus based on the display of the HUD.

The control unit may specify an actual power supply position, which is a position of the power supply apparatus present at a sight line destination of a driver of the vehicle through the HUD, corresponding to a position indicated by the power supply position information, and may cause an image (307) showing a position of the power supply apparatus to be displayed at a position of the HUD corresponding to the actual power supply position as the guide information.

According to this configuration, from the driver's point of view, since the power supply apparatus at the sight line destination through the HUD and an image showing the position of the power supply apparatus displayed on the HUD appear to be superimposed, the driver can move the vehicle to the position of the power supply apparatus based on the display of the HUD.

The control unit may specify a traveling trajectory that reaches the actual power supply position from a position indicated by the vehicle position information, and may cause an image (308) showing the traveling trajectory to be displayed in an area on the HUD corresponding to the traveling trajectory as the guide information.

According to this configuration, from the driver's point of view, since a road at the sight line destination through the HUD and an image showing the traveling trajectory to the position of the power supply apparatus displayed on the HUD appear to be superimposed, the driver can move the vehicle to the position of the power supply apparatus based on the display of the HUD.

When a distance from a position indicated by the vehicle position information to a position indicated by the power supply position information is equal to or larger than a predetermined threshold, the control unit may cause the information (305) indicating a path from the current position of the vehicle to the position indicated by the power supply position information to be displayed on the HUD as the guidance information.

According to this configuration, when the distance to the power supply apparatus is equal to or larger than the threshold, from the driver's point of view, the road at the sight line destination through the HUD and the information (305) indicating the path to the power supply apparatus displayed on the HUD appear to be superimposed. Therefore, the driver can move the vehicle to the position of the power supply apparatus based on the display of the HUD when the power supply apparatus is positioned relatively far.

When the distance from the position indicated by the vehicle position information to the position indicated by the power supply position information is less than the threshold, the control unit may cause an image (308) showing the traveling trajectory that reaches the position indicated by the power supply position information from the position indicated by the vehicle position information to be displayed on the HUD as the guidance information.

According to this configuration, when the distance to the power supply apparatus is less than the threshold, the road at the sight line destination through the HUD and the image (308) showing the traveling trajectory that reaches the power supply apparatus displayed on the HUD appear to be superimposed. Therefore, the driver can move the vehicle to the position of the power supply apparatus based on the display of the HUD when the power supply apparatus is positioned relatively close.

The control unit may determine a width of the traveling trajectory based on a width of the vehicle.

According to this configuration, since the image (308) showing the traveling trajectory having the width determined based on the width of the vehicle is displayed on the HUD, the driver can efficiently acquire electric power from the power supply apparatus by causing the vehicle to travel or stop along the image showing the traveling trajectory displayed on the HUD.

The control unit may cause, an electricity price corresponding to electric energy acquired from the power supply apparatus by the vehicle or an electricity price (310) corresponding to electric energy transmitted by the power supply apparatus, to be displayed on the HUD.

According to this configuration, since the electricity price corresponding to the electric energy acquired from the power supply apparatus by the vehicle or the electricity price corresponding to electric energy transmitted by the power supply apparatus is displayed on the HUD, the driver can recognize the electricity price for the wireless power transfer from the display of the HUD.

The control unit may cause power transmission efficiency calculated based on electric energy acquired from the power supply apparatus by the vehicle and electric energy transmitted by the power supply apparatus to be displayed on the HUD.

According to this configuration, since the power transmission efficiency between the electric energy acquired from the power supply apparatus by the vehicle and the electric energy transmitted by the power supply apparatus is displayed on the HUD, the driver can recognize the power transmission efficiency at the time of the wireless power transfer from the display of the HUD.

Although the embodiment has been described above with reference to the accompanying drawings, the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in the above-described embodiment may be optionally combined within a range not departing from the scope of the invention.

A technology of the present disclosure is applicable to a vehicle capable of receiving power by a wireless power transfer.

This application is based on and claims priority to Japanese Patent Application No. 2020-051072 filed on Mar. 23, 2020, the entire contents of which are incorporated herein by reference.

1. A display control apparatus configured to control a display of a head-up display provided in a vehicle configured to receive power by a wireless power transfer, the display control apparatus comprising:
a processor; and
a memory having instructions that, when executed by the processor, cause the processor to perform operations comprising:
acquiring power supply position information indicating a position of a power supply apparatus that is installed in a road and configured to perform power reception by the wireless power transfer; and
causing the head-up display to display guidance information that guides the vehicle to the position indicated by the power supply position information.

2. The display control apparatus according to claim 1,
wherein the operations further comprise causing the head-up display to display information indicating whether the vehicle is set to perform the power reception by the wireless power transfer.

3. The display control apparatus according to claim 1,
wherein if a remaining amount of a battery of the vehicle is less than a threshold, the operations further comprise causing the head-up display to display a first icon or a second icon, the first icon indicating that an air conditioner and/or a heater is turned off in order to suppress consumption of the battery, the second icon prompting a turn-off of the air conditioner and/or the heater in order to suppress the consumption of the battery.

4. The display control apparatus according to claim 1,
wherein if the remaining amount of a battery of the vehicle is less than a threshold and the vehicle is set not to perform the power reception by the wireless power transfer, the operations further comprise causing the head-up display to display information prompting a change to setting for performing the power reception by the wireless power transfer.

5. The display control apparatus according to claim 1,
wherein the operations further comprise:
acquiring map information;
acquiring vehicle position information indicating a current position of the vehicle;
specifying a path from a position indicated by the vehicle position information to the position indicated by the power supply position information based on the map information, and
wherein the causing the head-up display to display guidance information comprises causing the head-up display to display information indicating the path.

6. The display control apparatus according to claim 1,
wherein the operations further comprise:
specifying an actual power supply position, which is a position of the power supply apparatus present at a destination of a sight line of a driver of the vehicle through the head-up display, corresponding to the position indicated by the power supply position information, and
wherein the causing the head-up display to display guidance information comprises causing the head-up display to display an image showing a position of the power supply apparatus at a position on the HUD corresponding to the actual power supply position.

7. The display control apparatus according to claim 6,
wherein the operations further comprise:
acquiring vehicle position information indicating a current position of the vehicle; and
specifying a traveling trajectory that reaches the actual power supply position from the position indicated by the vehicle position information, and
wherein the causing the head-up display to display guidance information comprises causing the head-up display to display an image showing the traveling trajectory in an area on the head-up display corresponding to the traveling trajectory.

8. The display control apparatus according to claim 1,
wherein the operations further comprise:
acquiring vehicle position information indicating a current position of the vehicle, and
wherein the causing the head-up display to display guidance information comprises causing the head-up display to display first path information indicating a path from a position indicated by the vehicle position information to the position indicated by the power supply position information, if a distance from the position indicated by the vehicle position information to the position indicated by the power supply position information is equal to or larger than a threshold.

9. The display control apparatus according to claim 8,
wherein if the distance is less than the threshold, the causing the head-up display to display guidance information comprises causing the head-up display to display an image showing a traveling trajectory that reaches the position indicated by the power supply position information from the position indicated by the vehicle position information.

10. The display control apparatus according to claim 8,
wherein the causing the head-up display to display guidance information comprises causing the head-up display to display second path information indicating a path to a destination such that the second path information is distinguished from the first path information.

11. The display control apparatus according to claim 7,
wherein the operations further comprise determining a width of the traveling trajectory based on a width of the vehicle.

12. The display control apparatus according to claim 7,
wherein the image showing the traveling trajectory comprises an image showing a target stop section of the vehicle at the power supply position.

13. The display control apparatus according to claim 7,
wherein the image showing the traveling trajectory comprises an image showing a stop line of the vehicle at the power supply position.

14. The display control apparatus according to claim 7,
wherein the image showing the traveling trajectory comprises an image for guiding the vehicle to a lane in which the power supply apparatus is installed.

15. The display control apparatus according to claim 1,
wherein the operations further comprise:
acquiring vehicle position information indicating a current position of the vehicle, and
wherein if the power supply position cannot be visually recognized by a driver, the causing the head-up display to display guidance information comprises causing the head-up display to display first path information indicating a path from a position indicated by the vehicle position information to the position indicated by the power supply position information.

16. The display control apparatus according to claim 1,
wherein the operations further comprise:
acquiring vehicle position information indicating a current position of the vehicle, and
wherein if at least one right turn or left turn is required to reach the power supply position, the causing the head-up display to display guidance information comprises causing the head-up display to display first path information indicating a path from a position indicated by the vehicle position information to the position indicated by the power supply position information.

17. The display control apparatus according to claim 1,
wherein the operations further comprise causing the head-up display to display an electricity price corresponding to electric energy acquired from the power supply apparatus by the vehicle or an electricity price corresponding to electric energy transmitted by the power supply apparatus.

18. The display control apparatus according to claim 1,
wherein the operations further comprise causing the head-up display to display power transmission efficiency calculated based on electric energy acquired from the power supply apparatus by the vehicle and electric energy transmitted by the power supply apparatus.

19. A display control method for controlling a display of a head-up display provided in a vehicle configured to receive power by a wireless power transfer, the display control method comprising:
acquiring power supply position information indicating a position of a power supply apparatus that is installed in a road and configured to perform power reception by the wireless power transfer, and
causing the head-up display to display guidance information that guides the vehicle to the position indicated by the power supply position information.

20. A vehicle configured to receive power by a wireless power transfer, the vehicle comprising:
a head-up display;
a processor; and
a memory having instructions that, when executed by the processor, cause the processor to perform operations comprising:
acquiring power supply position information indicating a position of a power supply apparatus that is installed in a road and configured to perform power reception by the wireless power transfer; and
causing the head-up display to display guidance information that guides the vehicle to the position indicated by the power supply position information.
